(19) United States
(12) Patent Application Publication
(10) Pub. No.: US 2010/0293369 A1
(43) Pub. Date: Nov. 18, 2010

(54) METHOD FOR REACTIVATION OF A SECURE COMMUNICATION LINK

(75) Inventor: Jurgen Ramharter, Wien (AT)

Correspondence Address: K&L Gates LLP, P.O. BOX 1135, CHICAGO, IL, 60690, US

(73) Assignee: Nokia Science Networks GmbH & Co KG

(21) Appl. No.: 12/377,800

(22) PCT Filed: Jul. 11, 2007
(86) PCT No.: PCT/EP07/57089

§ 371 Date: Feb. 17, 2009

(30) Foreign Application Priority Data
Aug. 17, 2006 (DE) 10 2006 038 599.3

(51) Int. Cl. H04L 29/06

(52) U.S. Cl. 713/151; 713/162

(57) ABSTRACT

The invention relates to a method of reactivating a safe communication connection between client computers and a server after restarting the server, wherein safe communication connections are provided between the server and the client computers for the transmission of data. After restarting, or rebooting the server, a data packet is therefore transmitted (3) to the addresses of the client computers, wherein the server recognizes from the addresses of the client computers that a safe communication connection is provided (4, 5) for the transmission of data to these client computers. This safe communication connection, however, has been interrupted by the restarting of the server. By means of the transmission of the data packet to the addresses of the client computers, the processes for reactivation of the safe communication connection between the server and the client computers is triggered (6, 8). The advantages achieved according to the invention are particularly that the reactivating of the safe communication connection is triggered in a simple manner immediately after the restarting of the server, thus keeping any communication errors between the server and the client computer brief. Further, no additional administration effort is generated at the server due to the method according to the invention.

### CLAIM FOR PRIORITY

This application is a national stage application of PCT/EP2007/057089, filed Jul. 11, 2007, which claims the benefit of priority to German Application No. 10 2006 038 599.3, filed Aug. 17, 2006, the contents of which hereby incorporated by reference.

### TECHNICAL FIELD OF THE INVENTION

The invention relates to a method for reactivation of a secure communication link between client computers and a server after restarting of the server, with secure communication links being provided for transmission of data packets between the server and the client computers.

### BACKGROUND OF THE INVENTION

Communication networks make services available for communication purposes to users who have access to a communication network via, for example, a computer, terminal or other such terminals. Services such as these are, for example, the transmission of voice or data, primarily in the form of packets.

Communication networks such as company networks or LANs, or else large networks such as the Internet, which at the moment are used mainly for the transmission of data—in particular in packet form, can be distinguished on the basis of their architecture—that is to say on the basis of the conceptual design of the communication network. For example, in addition to so-called host systems in which the users are connected via terminals or data terminals to a generally powerful central computer or mainframe, or so-called peer-to-peer systems, in which all the computers in the communication network have equal authority, so-called client-server systems also exist.

In the case of a client-server system, a distinction is drawn between two types of computers in the communication network—so-called servers and so-called clients or client computers.

In this case, the server represents a network element or a computer in the communication network from which services—so-called server applications or applications—are offered centrally for a plurality of other network elements or computers—the so-called clients or client computers. The clients or client computers use these server services, and the user is offered access to the central services of the server by means of a user interface. The client computer makes contact with the server for this purpose. This principle is also referred to as the client-server principle. This makes it possible to make better use of resources (for example applications, databases, etc.) than if each client computer were to keep these resources available for itself locally and permanently, but only for occasional use.

Servers can be connected to the client computers via a local network (for example a company network, Local Area Network (LAN), etc.). However, a client computer can also access the server via telecommunication networks of widely differing types, such as the Internet, etc.

The communication—that is to say the interchange of data—between the server and the client computers via a communication link generally takes place on the basis of the client-server principle. By way of example, the expression “communication link” in this case refers to a usable, connected-through physical line or else a so-called virtual path between fixed-defined points in a communication network—such as a server and client computer.

The rules from which the format and meaning of the messages and data interchanged via the communication link are defined are referred to as a protocol which, for example, may be formed from a plurality of layers, such as a network layer, transport layer or application layer. The protocol which is used for interchanging data and messages depends on the nature and the field of use of the server.

For example, servers which use the so-called HyperText Transfer Protocol (http) on the application layer for transmission of data (for example web pages, etc.) via a network (for example the Internet), are also referred to as http servers. Other servers which implement protocols such as the File Transfer Protocol (FTP) as a protocol on the application layer in order, for example, to transmit files from a server to a client computer, from a client computer to a server, or on a client-controlled basis between two servers, can in general also be referred to as file servers or data servers. In the case of http or FTP, for example, the so-called Transmission Control Protocol (TCP) is used on the so-called transport layer, and is used to agree the manner in which data will be interchanged between the computers. By way of example, the so-called Internet Protocol (IP) is frequently used on the so-called network layer, by means of which exact agreements are reached on the basis of which data will be interchanged between computers or processes which are connected to one another by a communication network. A client-server system which uses the Internet Protocol IP for communication links can also be referred to as an IP-based client-server system.

A communication link is also referred to as a secure communication link when an authentication process is carried out at least when setting up a communication link between two computers (for example a server and client computer), ensuring that the two computers are authorized to carry out this communication link. When setting up the secure communication link, it is possible to use this authentication process to determine whether a communication link is also being set up with the correct communication partner—that is to say with that computer (for example server) to which, for example, it is intended to transmit data. In addition, for example during an existing communication link, it is possible to carry out authentication processes at different time intervals, in order to continually check whether a communication partner (for example a computer, server, client computer, etc.) is legitimated for the transmission of specific data or, for example, whether the communication link is still a secure link. This makes it possible, for example, to protect a communication link against eavesdropping or access by unauthorized parties to confidential data during transmission.

In some communication networks, the authentication process is also combined with an encryption process, for protection against unauthorized access. In this case, by way of example, a scheme comprising a request and response is used between the communication partners (for example a client computer, server, etc.) during the authentication process, by means of which each computer which is involved in the secure communication link verifies that a common encryption system exists and that this computer is thus authorized to participate in the secure communication link. In this case, by way of example, common but secret digital certificates or keys are interchanged.

Communication networks which use the so-called Internet Protocol (IP) as a protocol on the network layer are also referred to as IP networks. Since 1998, a specific security method—the so-called IP Security (Protocol) IPSec has been developed for communication links via these networks, and in the meantime has been defined by the Internet Engineering Task Force IETF in a number of Requests for Comments (RFC). In this case, RFC 2401 dated 1998 and RFC 4031 dated December 2005 describe the structure of IPSec, as main documents, so to speak. IPSec is intended to ensure secure transmission of data in IP networks, and thus protection aims such as confidentiality, authenticity and integrity. IPSec allows the setting up of secure communication links, and thus secure data transmission. In this case, IPSec security services (for example access monitoring, authentication methods, confidentiality, etc.) are provided which allow computers in an IP network to select an appropriate security protocol for a secure communication link, to define algorithms for use of the IPSec services, and to define constraints for definition of encryption parameters (for example keys, key length, etc.) which are preconditions for the IPSec services. In this case, IPSec makes use of two mechanisms:
the IP Authentication Header mechanism (AH) which handles the authentication and identification of a data source. This mechanism is described by the IETF in RFC 2402 and RFC 4302, and
the Encapsulation Security Payload (ESP) which is used for selective encryption of the data in the so-called transport mode, in which the so-called header of a data packet is not encrypted, or in the so-called tunnel mode in which all of the data is encrypted. This mechanism is described by the IETF in RFC 2406 and in RFC 4303.

A database, the so-called Security Policy Database SPD, is designed to manage which parameters are intended to be used by IPSec in which computers in a communication network and which addresses, which are allocated to the respective computers and via which these computers can be addressed. All the necessary information for the corresponding computers—separated on the basis of source and destination address for the dispatch of data—is stored in this database. When data is dispatched, the SPD database is then checked to verify the procedure for this data, in which case there are in principle three options: the data should be rejected, that is to say the address of the receiving computer is blocked; the data is passed on unchanged, or IPSec should be used for the data.

For the situation in which IPSec should be used for the data transmission in a communication link, the corresponding encryption parameters can then be taken from the SDP —combined in a so-called Security Association SA. An SA normally exists only when data is interchanged relatively frequently between computers and their addresses. If this is not the case, then an SA must be set up before interchanging data, when setting up a secure communication link. This can be done manually by using network management or using the International Security and Key Management Protocol ISAKMP, which can also be referred to as the Internet Key Exchange (IKE) protocol.

The ISAKMP or IKE protocol is defined in RFCs 2408, 2409 and 4306 from the IETF and is used to manage encryption processes in IP-based networks in which IPSec is used. ISAKMP or IKE is in this case used before the actual secure data transmission with IPSec for authentication of the transmitting and receiving computers and for negotiating encryption processes and the SAs between the computers, and this is done in two phases. First of all, in a first phase, an SA—the so-called Phase1 SA—is defined for secure transmission of the ISAKMP data (for example identification of a computer, encryption method used, etc.). In a second phase, an SA—the so-called Phase2 SA—for encryption of the data which is intended to be transmitted in a secure form by means of IPSec, is then negotiated between the computers and the corresponding encryption information is interchanged, generally already encrypted, between the computers.

The negotiated SAs in the first and the second phases may also have their validity duration restricted, for example by definition of a time period or an amount of transmitted data for which the SA is valid. Once the validity duration of an SA has lapsed, a new authentication process or renewal of the encryption parameters, for example, is then necessary.

Security presets and/or encryption data (for example encryption methods, keys, key length, etc.), for example in the form of SAs in the case of IPSec, are/is interchanged between computers participating in a communication link, and can also then be invalid or rejected when a so-called reboot or restart is carried out by a computer which is participating in a secure communication link. In the event of a reboot, the computer is started up again—that is to say the so-called operating system which, for example, manages equipment in the computer such as memory, input/output devices, etc., controls the running of programs, etc., is reloaded and in the process, for example, major components of the computer are tested and initialized.

After a reboot, a computer normally only then sets up processes for secure communication links (for example authentication, dispatch of new security presets and/or encryption data, etc.) to other computers when data is intended to be transmitted to these computers again—this is also the situation when secure communication links to these computers already existed before the reboot. By way of example, when using IPSec, new Phase1 SAs and new Phase2 SAs are interchanged with another computer after a reboot only when the computer which had just carried out a reboot is to transmit the first data packet to this other computer. If a secure communication link to this other computer already existed before the reboot and corresponding SAs, which are still valid from its point of view, are thus stored on this computer, then these are rejected and the newly interchanged SAs are used for further communication.

In the case of client-server systems which communicate on the basis of the client-server principle, the communication is normally initiated at the client computer end, but not by the server. This means that, in the event of a client computer reboot, although the processes for a secure communication link will be passed through immediately when contact is first resumed, a reboot of the server can, however, lead to gaps in communication when using secure communication links, for example by means of IPSec.

In the situation in which no contact to the client computers is started by a server, the reboot will not be identified by a client computer which is sending data via a secure communication link to the server. For example, the client computer will still be using the security presets interchanged before the reboot and/or encryption data for data transmission via the secure communication link. Since, for example, the corresponding encryption data will no longer be valid as a result of the reboot at the server, the data transmitted via the secure communication link can then, for example, no longer be identified, decrypted or read by the server. The data is therefore normally rejected by the server.

The communication between the server and the client computer via the secure communication link cannot resume until appropriate processes (for example authentication, dispatch of new security presets and/or encryption data, etc.) have been initiated at the client computer end for a secure communication link because, for example, the validity duration of the security presets and/or encryption data stored in the client computer has lapsed. This means that the data transmitted via the secure communication link will not be recognized again by the server until this has been done.

Since, however, in the case of IPSec for example, the validity duration of the Phase1 SAs in which security presets such as identification of a computer, encryption methods used, etc. are defined may be relatively long (for example up to 24 hours), long communication gaps can thus occur after the reboot of a server. If, for example, the validity duration of the Phase1 SA is dependent on the amount of data transmitted, then it is possible for this SA to no longer be invalid at the client computer end as a result of a server reboot, and for it therefore to no longer be possible for the client computer to initiate the processes for a secure communication link.

One possible way to prevent this would, for example, be to also reset the existing SAs at the client or clients or in fact to reboot the client or clients after a reboot of the server, since the corresponding processes for setting up a secure communication link would then be initiated at the client end. However, this procedure is highly complex and is dependent on the client or clients being informed of every server reboot.

A further possible way for a client computer to find out whether a secure communication link is still active is, for example, the so-called Dead Peer Detection DPD, which is used for example in the case of IPSec, in particular in the tunneling mode. In the case of DPD, status messages are interchanged regularly between the server and client computer and are used to determine whether the communication link is still active. If no response is received to the DPD message within a time limit, the communication link (for example IPSec tunnel) is closed until it is reactivated by a new data transmission. However, in order to use it, the DPD must be activated both in the server and in the client computer. However, since DPD is not currently standardized, DPD is not implemented, and therefore available, on all computer systems. Furthermore, DPD generates additional data traffic and management data as a result of the regular transmission of status messages.

### SUMMARY OF THE INVENTION

The present invention specifies a method in which processes for reactivation of a secure communication link between a server and client computers are started by a server in a simple manner after a reboot or restart of this server.

In one embodiment, there is a method in which, after restarting of the server, a data packet is sent to addresses of the client computers, wherein the server transmits on the basis of the addresses of the client computers. The server uses the addresses of the client computers to identify that a secure communication link has been provided for the transmission of the data packet but has been interrupted by the restarting of the server, and the dispatch of this data packet initiates processes for reactivation of the secure communication links between the server and the client computers.

Advantages that may be achieved by the invention are that reactivation of the secure communication links is initiated in a simple manner directly after the restart of the server, as a result of which any communication failures between the server and client computer are kept short. Another exemplary advantage is that the secure communication link between the server and the client computers is already activated while the server is being started up, and the time duration for starting up is therefore kept short. Furthermore, the method according to the invention does not generate any additional management effort at the server.

It is also advantageous for the secure communication link to be set up between the server and the client computers using Internet Protocol Security IPSec in accordance with RFC 2401 and/or RFC 4301 of the IETF, since IPSec has been standardized by the IETF in a number of RFC—for example such as RFC 2041 or RFC 4301 as a main document. In addition, the IETF has defined mechanisms such as the IP Authentication Header Mechanism, Encapsulation Security Payload, etc. and protocols such as ISAKMP, etc. for IPSec in further RFCs (for example RFC 2402, RFC 4302, RFC 2406, RFC 2408, RFC 4306, etc.).

Another embodiment of the invention provides for the data packet to be sent by so-called startup software which runs on the server between the execution of operating system software and an application, with the startup software being part of the middleware software which is used for switching between operating system software and applications and is therefore run before starting an application. A secure communication link is therefore activated even before the start of an application which is dependent on there being a secure communication link between the server and the client computers, and the time period required for starting up is thus kept short.

The data packet is preferably sent to the addresses of client computers for which a secure configuration link has been configured at the server, wherein these addresses for dispatch of the data packet can be read from the Internet Key Exchange Policy file, for example using IPSec. For example, in the case of IPSec, those addresses of client computers to which a secure communication link is intended to be set up are administered in this file. Since this configuration data is already available at the server, no additional administration effort is therefore required for dispatching the data packet for reactivation of a secure communication link.

In still another embodiment of the invention, the data packet is sent to the addresses of those client computers for which a valid secure communication link had been provided prior to the restart, in which case, ideally, these addresses can be stored in a file by the server for example before the restart or when a secure communication link is set up for the first time to this client computer. This variant of the method according to the invention is particularly worthwhile when the address areas are administered, rather than the individual addresses of the client computers during the configuration of the addresses for secure communication links, for example in the Internet Key Exchange Policy file for IPSec. In a simple manner, this avoids a heavy data load resulting from the transmission of the data packet to the administered addresses and address areas, in particular when a secure communication link has not been set up for the administered client computers before the restart, for example because client computers are actually not switched on.

It is also expedient for a data packet to be sent, using the User Datagram Protocol UDP, in order to initiate the processes for reactivation of the secure communication link, since UDP has been standardized by the IEFT in RFC 768 and represents a minimal, connectionless protocol, for transport of data packets on the so-called transport layer. Furthermore, in comparison to other protocols of the transport layer, such as TCP, UDP is faster and has a greater length for the data packets, thus keeping the data traffic generated by the dispatch of the data packets low.

It is also advantageous, in the case of a data packet using the UDP protocol, to also send a comparatively high port number, such as the port number 33434, etc., as the destination port number. Since the high port numbers, for example, are not used by applications and are therefore unused, the UDP data packet is normally not observed when it is received by a client computer. However, nevertheless, the initiation of the processes for reactivation of the secure communication link is carried out by the UDP packet since these processes are started by the dispatch to the server.

Furthermore, the “shared Security Associations (SAs)” may be used for the method according to the invention—in particular in conjunction with IPSec. In the case of shared SAs, dedicated SAs are not generated for each protocol that is used and for each port number. Since shared SAs avoid the generation of additional data on the server and the client computers, shared SAs are normally frequently used.

### BRIEF DESCRIPTION OF THE DRAWINGS

The invention will be explained in an exemplary manner in the following text with reference to the attached figure.

FIG. 1 shows, schematically, the procedure in the method according to the invention for reactivation of a secure communication link.

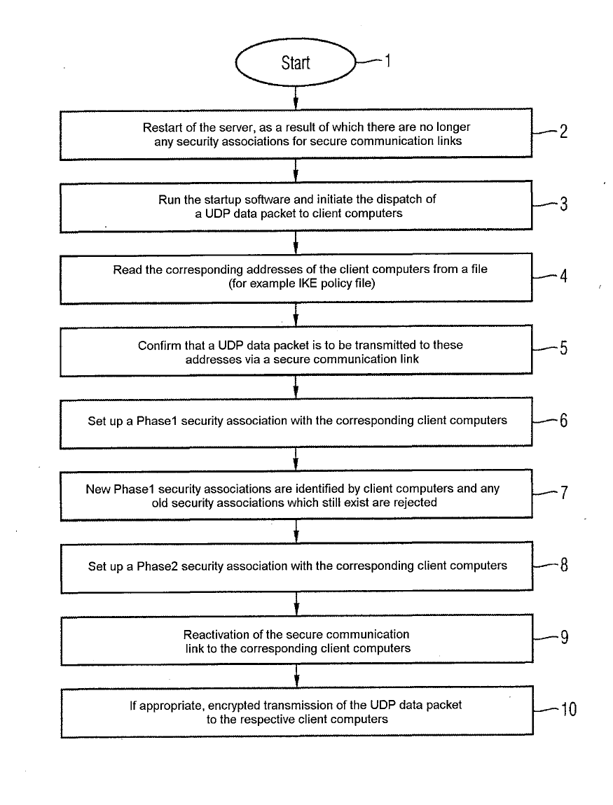

### DETAILED DESCRIPTION OF THE INVENTION

The method according to the invention will be described, by way of example, for an IP-based client-server system, which uses IPSec as a security method. The method according to the invention can, however, also be used for other (non-IP-based) client-server systems or when using other security methods for communication links.

The method starts with a start step 1. In a second method step 2, a restart or a reboot of a server of an IP-based client-server system, which uses IPSec for secure communication links, is carried out. As a result of the reboot, all the active secure communication links at the server end are deactivated—that is to say the Phase1 and Phase2 security associations in existence for these communication links lose their validity and are rejected at the server as a result of the reboot at the server.

In a third method step 3, for example while running the startup software which is run between operating system software and software for applications, dispatch of a data packet is initiated using the User Datagram Protocol UDP—a so-called UDP data packet.

In a fourth method step 4, addresses of client computers are read by the server from a file, for the dispatch of the UDP data packet. In the case of IPSec, by way of example, a so-called IKE policy file or data stored in the Security Policy Database SPD may be used for this purpose when, for example, the UDP data packet is intended to be sent to all the client computers for which a secure communication link has been configured at the server. If the UDP data packet is intended to be sent only to each client computer to which a secure active communication link actually existed before the restart, then the addresses of these client computers can be stored on a dedicated file in the server, and this file is then used for the dispatch of the UDP data packet.

On the basis of the addresses of the client computers and since these addresses have been entered, for example, in the Security Policy Database SPD or the IKE policy file, the server determines in a fifth method step 5 that the UDP data packet must be transmitted to these client computers via a secure communication link. In a sixth method step 6, the server, for example in the case of IPSec, therefore sets up a Phase1 Security Association SA with the corresponding client computers. The so-called ISAKMP data (for example identification of a computer, encryption methods used, etc.) is defined in this Phase1 SA for secure transmission.

In a seventh method step 7, the corresponding client computers identify the new Phase1 SA which has been set up by the server. The client computers then reject any SAs which may still exist for secure communication links to the server, and use the new Phase1 SA.

In the case of IPSec by way of example—corresponding to the two-step nature of this security method—the server then sets up a new Phase2 SA with the client computers in an eighth method step 8, in which SA, for example, the encryption of the data to be transmitted is defined. The client computers then also use the new Phase2 SA.

In the case of IPSec by way of example, a secure communication link to a client computer is reactivated in a ninth method step 9 by the server setting up new Phase1 and Phase2 SAs. In a tenth method step 10, the UDP data packet can then be encrypted in accordance with the security method being used and its mechanisms (for example IPSec), and can be transmitted to the respective client computer. In this case, in the case of the UDP data packet by way of example, a high port number is entered as the destination port number, for example the port number 33434, since it is irrelevant whether the UDP data packet is actually received by the client computers. If the UDP data packet is received by a client computer, then, because of the high port number, for example, it is not considered any further or is rejected, and, for example, the client computer sends a response to the server that the destination port number cannot be accessed.

Since, however, the secure communication link between the server and the corresponding client computer has been reactivated in a simple and quick manner by the method according to the invention, data can then be transmitted once again in a secure form and, for example, encrypted, via this communication link.

1. A method for reactivation of secure communication links to client computers after restarting of a server, with these secure communication links being provided for transmission of data packets between a server and client computers, comprising:
sending, after restarting of the server, a data packet to addresses of the client computers;
identifying, based on the addresses, that a secure communication link has been provided for the transmission of the data packet and has been interrupted by the restarting of the server; and
initiating processes for reactivation of the secure communication links between the server and the client computers as a result of the dispatch of the data packet.

2. The method as claimed in claim 1, wherein the secure communication link is set up between the server and the client computers using Internet Protocol Security IPSec in accordance with RFC 2401 and/or RFC 4301 of the IETF.

3. The method as claimed in claim 1, wherein the data packet is sent by startup software which runs on the server between the execution of operating system software and an application.

4. The method as claimed in claim 1, wherein the data packet is sent to the addresses of client computers for which a secure configuration link has been configured at the server.

5. The method as claimed in claim 4, wherein the addresses for dispatch of the data packet are read from an Internet Key Exchange Policy file.

6. The method as claimed in claim 1, wherein the data packet is sent to the addresses of the client computers for which a valid secure communication link had been provided prior to the restart.

7. The method as claimed in claim 6, wherein the server stores in a file the addresses of those client computers to which a secure communication link is set up after restarting of the server.

8. The method as claimed in claim 1, wherein a data packet is sent, using the User Datagram Protocol UDP, to initiate the processes for reactivation of the secure communication link.

9. The method as claimed in claim 8, wherein, in the case of a data packet using the UDP protocol, a comparatively high port number is also sent as the destination port number.
